(19) United States
(12) Patent Application Publication
(10) Pub. No.: US 2009/0301398 A1
(43) Pub. Date: Dec. 10, 2009

(54) Feed Barrier for Livestock

(76) Inventor: Johannes Martinus Willibrordus Weelink, Vries (NL)

Correspondence Address: LADAS & PARRY LLP, 26 WEST 61ST STREET, NEW YORK, NY, 10023, US

(21) Appl. No.: 12/085,136

(22) PCT Filed: Nov. 20, 2006
(86) PCT No.: PCT/NL2006/000579

§ 371 Date: Feb. 25, 2009

(30) Foreign Application Priority Data
Nov. 18, 2005 (NL) 1030468

(51) Int. Cl. A01K 5/00

(52) U.S. Cl. 119/57.9; 119/57.92

(57) ABSTRACT

The invention relates to a feed barrier (2) for animals and a locking device for such a feed barrier, comprising a left and a right post (25, 26) bounding a feeding location for an animal, wherein the left and the right post are rotatable about a first and second centre line (27), respectively, between an open and a closed position, and wherein the left and the right post have a curved shape, wherein a part of the left and right post in the open position are bent away from each other in order to form a passage for the animal's head, and in the closed position are bent towards each other according to a shape substantially adapted to the shoulder blades and/or neck of the animal.

### BACKGROUND OF THE INVENTION

The invention relates to a feed barrier intended for animals of a specific category of animals, such as for instance dairy. cattle, fatting calves, pigs, fatting bulls and the like. Feed barriers especially intended for each of these specific categories are made and supplied, as the dimensions of the animals of each category may strongly vary.

Such a feed barrier is for instance known from applicant's Dutch patent application 1008797. The feed barrier described in this patent application at least comprises a girder and a number of posts arranged thereon, of which posts each time a pair bounds a feeding location for an animal, wherein the pair of posts each are rotatable about a substantially vertical centre line between an open position in which there is a relatively large space between the posts and a closed position in which the space between the posts is smaller, wherein the pair of posts have a curved shape adapted to the chest of the animals of said category. As soon as the animal sticks its head through the relatively large space between the posts, the posts are pushed into the closed position by the chest of the animal. The barrier may furthermore be provided with locking means with which the posts can be locked in the closed position, so that the animal secures itself in the feeding barrier. As the posts have a curved shaped adapted to the animal's chest, the animal's comfort is increased and physical damage can be effectively avoided.

Although the feed barrier according to Dutch patent application 1008797 improves the comfort of the animals to a large degree with respect to the feed barriers known up until then, it is an object of the invention to further increase said comfort.

### SUMMARY OF THE INVENTION

According to a first aspect the invention provides a feed barrier comprising a left and a right post bounding a feeding location for an animal, wherein the left and the right post are rotatable about a first and second centre line, respectively, between an open and a closed position, and wherein the left and the right post have a curved shape, wherein a part of the left and right post in the open position are bent away from each other in order to form a passage for the animal's head, and in the closed position are bent towards each other according to a shape substantially adapted to the shoulder blades and/or neck of the animal.

The feed barrier according to the invention is intended to offer improved comfort to animals that exert a pressure on the feed barrier, for instance when the animal tries to move its head upwards along the posts placed in the closed position, or when the animal exerts a forward pressure on the feed barrier for instance when taking in fodder. By adapting the shape of the posts according to the invention to the shoulder blades and/or neck of animals of a specific category of livestock, an improved distribution of said pressure of the feed barrier on the shoulder blades and/or neck of the animals placed between the posts in closed position, is achieved. As a result the risk of possible injuries to the shoulders and/or neck of the animal can be reduced and the comfort of the animals can be improved.

The known posts in the feed barrier are adapted for obtaining a proper abutment of the posts against the chest of the animals for improving the comfort of the animals. The comfort is improved in particular when the animal secures itself in the feeding location. The inventor realised that the known shape of the posts is intended to distribute a forward pressure of the animal's chest against the feed barrier, and that the known feed barrier should furthermore prevent the animal from escaping from the feed barrier.

Contrary to the known posts the shape of the posts according to the invention is intended to improve the comfort of the animals particularly when the animal reaches far to obtain fodder. In that case the animal namely tends to lean against the feed barrier with its full weight. Due to the shape of the posts according to the invention the pressure of the feed barrier is better distributed over the shoulders and/or neck of the animal, as described above.

According to another or further aspect the left and right post in the closed position are bent towards each other, wherein a section of the part facing the lower side of the feed barrier is bent concavely. In one embodiment the distance between the left and right post in the section becomes substantially continuously smaller as a function of the distance to the lower side of the feed barrier.

In one embodiment, in the closed position, the course of the section of the left and right post also comprises a component that is oriented substantially transverse to feed barrier. Preferably the section runs continuously in a transverse direction as a function of the distance to the lower side of the feed barrier. Preferably the posts in the closed position run towards the rear side of the animal and towards each other, following the shoulder blades and the narrower neck of the animal. As a result a secured animal cannot escape and the pressure forces are effectively distributed over the animal's shoulder blades and/or neck.

In one embodiment the left and/or right post is curved in three or more planes that are substantially parallel to the centre line. Said embodiment offers sufficient degrees of freedom to the posts according to the invention to effectively distribute the pressure forces. For instance the lower part of the posts is bent away from the centre line in a first plane into a curved shape adapted to the animal's chest, the second part of the posts is bent in a second plane that is at a first angle, preferably an acute angle, to the first plane into a curved shape adapted to the shoulder blades and/or neck of the animal, and a third part of the posts is bent back in the direction of the centre line in a third plane that is at a second angle, preferably acute angle, to the second plane.

In one embodiment the feed barrier comprises an upper girder and a lower girder, wherein the left and the right post with their upper and lower ends are rotatably connected to the upper and lower girder. In one embodiment thereof the part having a shape adapted to the shoulder blades and/or neck of the animal is situated near the upper girder, wherein the left and right post at a side of the part or below the part facing the lower girder in the open position are bent towards each other for forming a stop part for an animal's chest. This embodiment combines the shape of the known posts with the shape of the posts according to the invention. In that case a lower part of the posts has a curved shape adapted to the animal's chest and an upper part has a curved shape adapted to the animal's shoulder blades and/or neck. A feed barrier according to this embodiment is particularly advantageous because such a feed barrier is able to distribute the pressure over the entire front (chest, shoulders and neck) of the animal.

In one embodiment the stop part for the animal's chest of the left and right post, in the closed position extends substantially beyond a plane defined by the upper and lower girder. In one embodiment the part of the left and right post having a shape adapted to the shoulder blades and/or neck of the animal, in the closed position also extends substantially beyond a plane defined by the upper and lower girder.

In one embodiment the first centre line is spaced apart from the second centre line. In one embodiment the first and second centre line are oriented substantially vertical and/or parallel. In one embodiment the left and right post comprise a substantially mirror-symmetrical curved shape with respect to each other.

In one embodiment the feed barrier comprises locking means for detachably locking the posts in the closed position. In that way the animals can be secured in the feed barrier. In an advantageous further embodiment the locking means are self-locking. That means that when an animal pushes a post into the closed position, the locking means rotation-fixedly fixate the post in said locked position. In that way the posts can be used as catching posts in a self-locking feed barrier, wherein the animals are able to secure themselves in the feed barrier.

In one embodiment the left and right post each at an end thereof facing the locking means comprise an unround part, preferably integrally formed with the post. In that case the locking means preferably comprise at least one locking girder that is placed so as to be movable and which can be brought into an operative connection with the unround end of the post for locking the rotation of the post.

In one embodiment each rotatable post is provided with a related locking girder. In an alternative embodiment a pair of rotatable posts is provided with one locking girder, wherein the girder thus extends to near the ends of both posts.

In a simple embodiment the unround end comprises a flattened part and the locking girder comprises one or more recesses for at least partially accommodating the flattened part.

In case of one locking girder per pair of rotatable posts, the locking girder at a side facing the left and right post, comprises a recess for in the closed position of the left and right post rotation-fixedly connecting the flattened part of the posts to the locking girder.

In one embodiment the locking girder is movable in a direction towards the left and/or right post for rotation-fixedly connecting the flattened ends of the posts to the locking girder, and in a direction away from the left and/or right post for uncoupling the flattened ends of the posts and the locking girder. In that way the locking means are easily activated and deactivated by moving the locking girder.

In a simple embodiment the locking girder is placed in a guide, wherein the guide guides the movement of the locking girder preferably along a third centre line that is substantially parallel to the first and/or second centre line. The locking girder is able to engage onto the flattened ends of the posts due to the sliding along the guide. In one embodiment the flattened parts have been placed at the ends of the posts and the locking girder falls over the flattened ends of the posts wherein said flattened ends are accommodated in the recesses of the locking girder.

In one embodiment having one locking girder per pair of rotatable posts, the locking girder is connected to the feed barrier so as to be movable substantially between the first and second centre line. Preferably said locking girder is connected to the feeding barrier at one position thereof, which position preferably is situated substantially in between the first and second centre line.

In one embodiment the feed barrier comprises manual operating means and/or a drive for moving the locking girder, at least for uncoupling the flattened ends of the posts and the locking girder. In one embodiment the drive comprises an electric, pneumatic or hydraulic drive. Manual operation renders a simple operation at the location of the feed barrier possible, whereas the drive also renders a remote operation and/or automated operation possible.

In one embodiment the manual operating means and/or the drive of various feeding locations can be operated individually and/or jointly, so that at choice at one or several feeding locations animals can be secured or indeed released.

In one embodiment the feed barrier further comprises a rail extending along the feed barrier, which rail is operatively connected to the locking girder for from one end of the feed barrier moving the locking girder along the guide. In this embodiment the locking girders of a number of feeding locations may furthermore be operatively connected to the rail, so that from the end of the feed barrier all connected locking means can be jointly unlocked.

In one embodiment the locking girder extends to above the left and right post. Particularly when the first and second centre line have been substantially vertically placed, the locking girder, due to gravity, may be pulled in the direction of the flattened ends of the posts and the locking girder driven by gravity may fall over the ends of the left and right post, at least in the closed position thereof, wherein the left and right post are rotation-fixedly connected to the locking girder.

In one embodiment the feed barrier comprises resistance means cooperating with the unround ends of the left and right post for offering resistance against rotation of the posts. Particularly against rotation out of the open position thereof.

In a simple embodiment the resistance means comprise at least one bar spring abutting the unround, preferably flattened end of the left and/or right post. In case of rotation out of the open position the bar spring exerts a spring force on said ends which spring force attempts to push the posts back to the open position. Said spring forces provide a moment (force×arm) onto the ends of the posts, urging the posts to the open position.

In one embodiment the resistance means comprise at least two bar springs in between which the unround, and preferably flattened end of the left and/or right post has been placed, wherein the bar springs have been placed for exerting a pressure force substantially on either side against the post, at least when the post rotates out of the open position. In one embodiment the bar springs have been placed substantially parallel, wherein the mutual distance between the bar springs preferably is smaller than the diameter of the posts, preferably exceeding or equalling the thickness of the flattened end of the left and/or right post. In the open position the two bar springs abut the level parts of the flattened ends of the posts. In case of rotation out of the open position a first side of the flattened end will be pushed against the first bar spring and a second side of the flattened end situated across the first side will be pushed against the second bar spring. The bar springs exert a spring force on the first and second side that attempts to push the sides back to the open position. Said spring forces provide a torque on the posts which urges the posts to the open position.

In one embodiment the unround, and preferably flattened ends of the posts have been formed and/or placed such that in the closed position as well the bar springs exert a torque or moment on the posts which pre-biasses the posts to the open position. As a result the bar springs will push the posts from the closed position, after unlocking, to the open position.

According to a second aspect the invention provides a locking device for a feed barrier comprising a left and a right post bounding a feeding location for an animal, wherein the left and the right post are rotatable about a first and second centre line, respectively, between an open position and a closed position, wherein the left and right post each at an end thereof facing the locking means comprise an unround part, preferably integrally formed with the post, wherein the locking device comprises at least one movable locking girder for in the closed position detachably locking both the left and the right post, wherein the locking girder is movable in a direction towards the left and/or right post for rotation-fixedly connecting the unround ends of the posts to the locking girder, and in a direction away from the left and/or right post for uncoupling the unround ends of the posts and the locking girder.

In one embodiment the locking device further comprises manual operating means and/or a drive for moving the locking girder, at least for uncoupling the unround ends of the posts and the locking girder.

In one embodiment the drive comprises an electric, pneumatic or hydraulic drive.

According to a third aspect the invention provides resistance means for a feed barrier comprising a left and a right post bounding a feeding location for an animal, wherein the left and the right post are rotatable about a first and second centre line, respectively, between an open and a closed position, wherein the left and right post each comprise an unround part at an end thereof, preferably integrally formed with the post, wherein the resistance means are placed in operative connection with the unround ends of the left and right post for offering resistance to rotation of the posts, particularly to rotation out of the open position thereof.

In a simple embodiment the resistance means comprise at least one bar spring abutting the unround, preferably flattened end of the left and/or right post.

The aspects and measures described in this description and claims of the application and/or shown in the drawings of this application may where possible also be used individually. Said individual aspects, such as the locking device and the resistance means such as the bar springs, and other aspects, may be the subject of divisional patent applications relating thereto. This particularly applies to the measures and aspects described per se in the sub claims.

### SHORT DESCRIPTION OF THE DRAWINGS

The invention will be elucidated on the basis of a number of exemplary embodiments shown in the attached drawings, in which:

FIG. 1 shows a schematic view in perspective of a feed barrier according to the state of the art;

FIGS. 2A, 2B and 2C show a front, top and side view, respectively, of a feed barrier according to the invention in the open position;

FIGS. 3A, 3B and 3C shows a front, top and side view, respectively, of a feed barrier according to the invention in the closed position;

FIGS. 4A, 4B and 4C show a front, side and top view, respectively, of a post according to the invention in the open position;

FIGS. 5A and 5B show a front view (partially in cross-section) and a view in transverse section, respectively, of an upper girder of a feed barrier according to the invention; and

FIGS. 6A and 6B show a front and a top view, respectively, of the resistance means according to the invention.

### DETAILED DESCRIPTION OF THE DRAWINGS

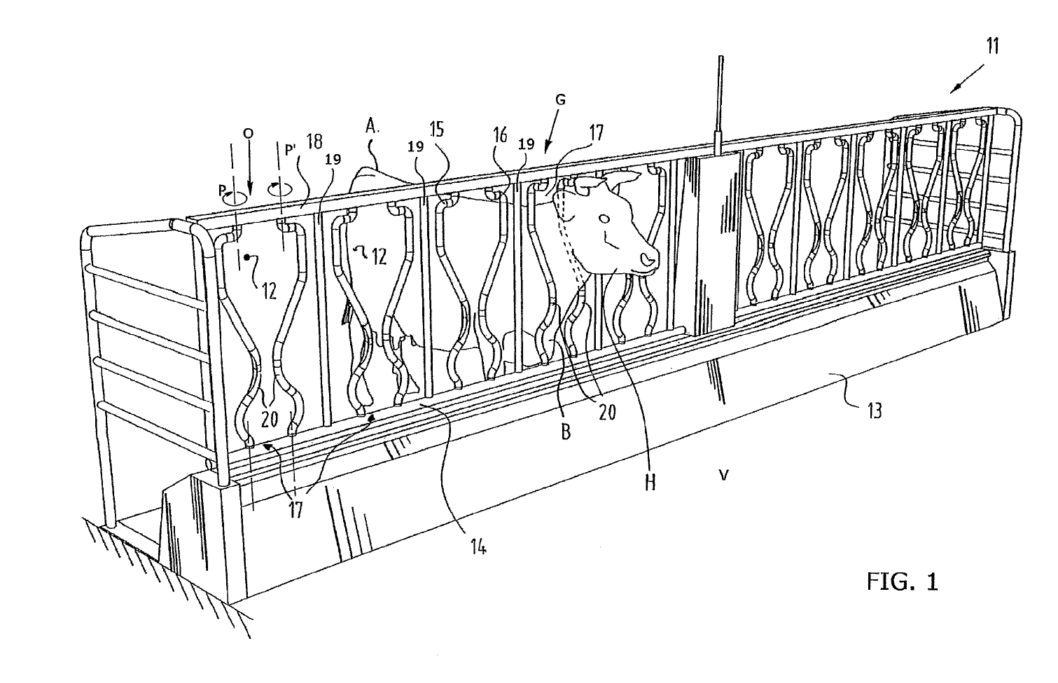

The feed barrier 11 shown in FIG. 1. is intended for a specific category of livestock, in this, case cattle and more particularly dairy cattle A. The dimensions of dairy cattle are within relatively narrow margins, so that the feed barrier 11 can be properly adapted to animals of this category.

The feed barrier 11 has been placed with a lower girder 14 thereof on a frame 13. The feed barrier 11 further comprises an upper girder 18 which by means of fixed posts 19 is connected to the lower girder 14. The feed barrier 11 further comprises a number of pairs of curved posts 15, 16 that are rotatable about a substantially vertical axis. Between each pair of posts 15, 16 a feeding location 17 is formed where an animal A is able to stick its head H through the feed barrier 11 in order to take in fodder lying at the front side V of the barrier 11. The posts 15, 16 are rotatable according to the arrows P, P′ between an open position O and a closed position G, respectively. In the open position O the curved parts 20 of the posts 15, 16 are oriented towards each other and in the closed position G said parts 20 have been moved apart and are more or less parallel to each other. The posts 15, 16, as shown in FIG. 1 have been bent in one plane.

When the animal A has stuck its head H through the hole 12, it will push its chest B against the curved parts 20, as a result of which the posts 15, 16 are rotated from the open position O to the closed position G.

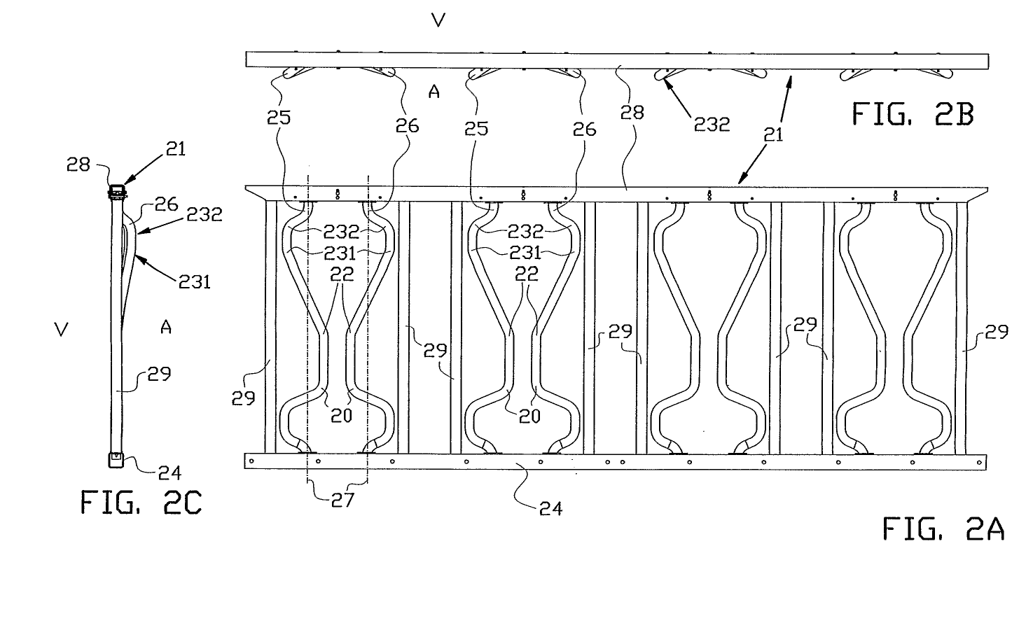

FIG. 2 shows an exemplary embodiment of a feed barrier 21 according to the invention, wherein the curved posts 25, 26 have been placed in the open position. Such a feed barrier 21 may on the one hand have been placed on a similar frame 13, as shown in FIG. 1, and on the other hand on or between two pillars. Contrary to the posts 15, 16 of the known feed barrier 11 the posts 25, 26 according to the invention have been bent substantially from position 22 to the rear side A of the feed barrier 21. This is clearly shown in the top view of FIG. 2B and the side view of FIG. 2C. From position 22 the posts 25, 26 have been bent at an obtuse angle from the plane of the feed barrier 21, wherein the posts 25, 26 have been bent in upward direction further and further beyond the plane of the feed barrier 21 until substantially at a position 231. From position 231 the posts 25, 26 run substantially parallel to the plane of the feed barrier 21, as shown in the side view of FIG. 2C, until substantially at a position 232. From position 232 the posts 25, 26 bend back again to the centre line 27 related to the post 25, 26. The part between the positions 231 and 232 ensures a sufficiently large opening for the head H of the animal A.

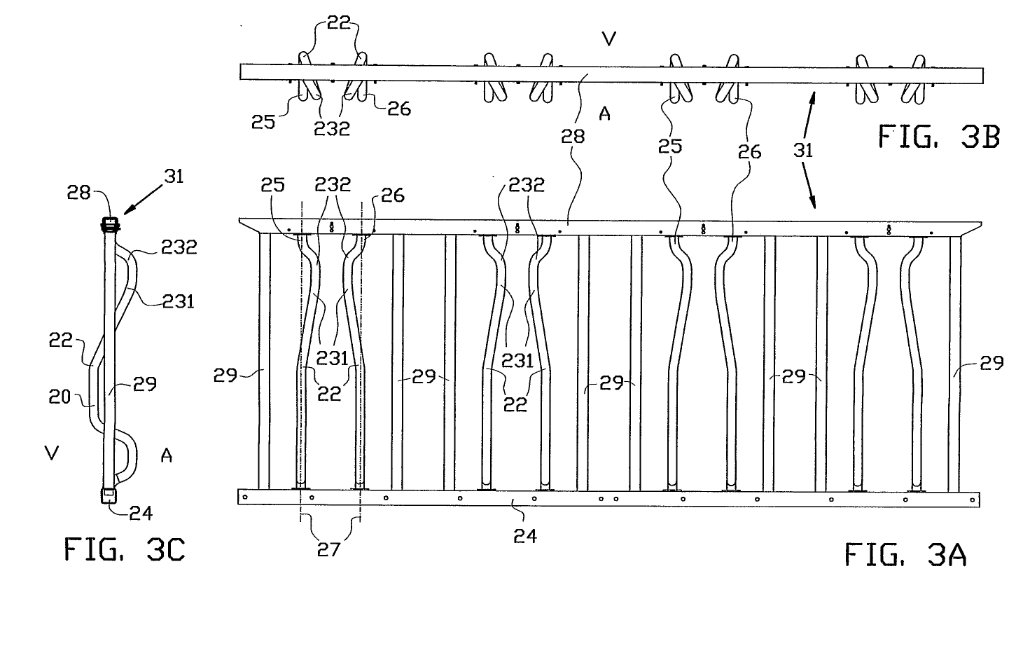

In FIG. 3 the exemplary embodiment of a feed barrier 31 according to FIG. 2 is shown in which the bent posts 25, 26 have been placed in the closed position. In this situation the posts 25, 26 have been rotated over an angle of substantially 90 degrees about the centre lines 27 with respect to the open position according to FIG. 2. Contrary to the posts 15, 16 of the known feed barrier 11 the posts 25, 26 according to the invention have been bent substantially from position 22 at an obtuse angle to the rear side A of the feed barrier 31 and towards each other. This is clearly shown in the side view of FIG. 3C and the front view of FIG. 3A. From position 22 the posts 25, 26 have been bent in upward direction inclined towards the rear side A and towards each other until substantially at a position 231. The section between position 22 and 231 thus is bent concavely, as shown in FIG. 3A. From position 231 the posts 25, 26 run substantially parallel to the plane of the feed barrier 21, as shown in the side view of FIG. 3C, until substantially at a position 232. From the position 232 the posts 25, 26 bend back again to the centre line 27 related to the post 25, 26. In the closed position, the posts 25, 26 in the upper part (from position 22), thus run rearwards and towards each other for following the shoulder blades and narrower neck of the animal A. As a result not only the comfort of the animal A is improved, but secured animals A, also those with a small head H, cannot escape and a secured animal A is secured indeed.

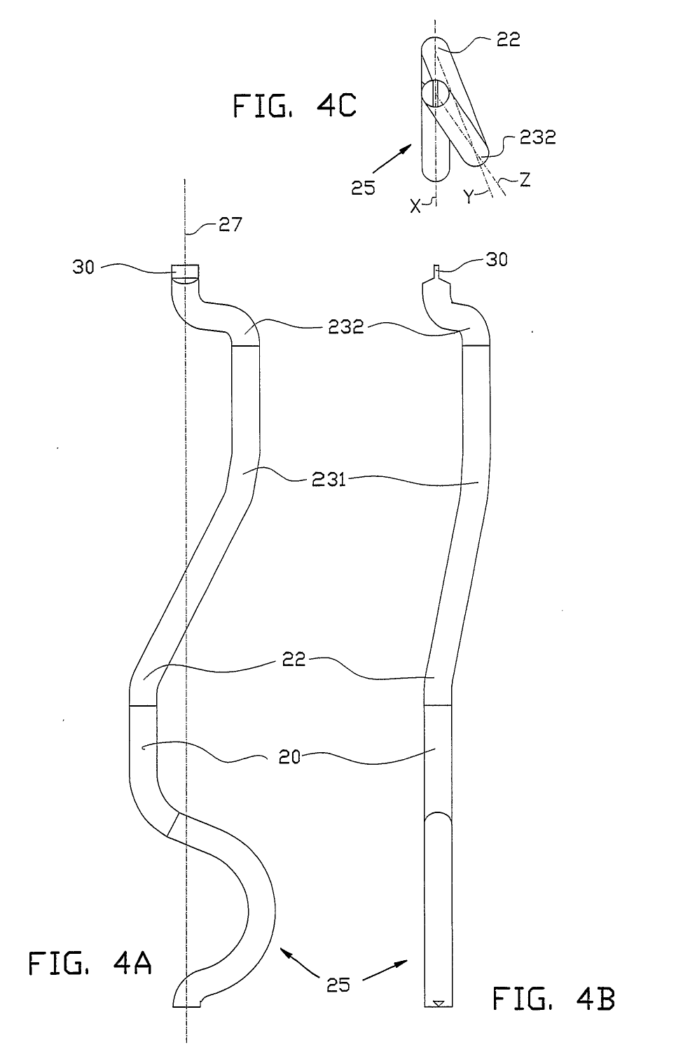

The shape of this exemplary embodiment of the post 25 according to the invention is shown in various views in FIG. 4. The other post 26 of the pair is a mirror-symmetrical embodiment of the post 25 of FIG. 4 (mirrored in the plane X of FIG. 4C). The lower part of the post 25 up to position 22, comprising the curved part 20, is bent in a plane X. From position 22 up to position 232 the post 25 is bent in a plane Y, wherein the plane Y has been placed at an acute angle to the plane X as shown in FIG. 4C. From position 232 the post 25 is bent in plane Z, wherein the plane Z has been placed at an acute angle to the plane Y and the plane X as shown in FIG. 4C.

Said exemplary embodiment is particularly suitable for cattle. For livestock of another category, such as for instance pigs, the shape of the post will also be curved according to a shape substantially adapted to the shoulder blades and/or neck of the animal. It will be clear to the expert that in case of another physical build of an average animal of the livestock category in question for which the feed barrier is designed, the shape of the posts will have to be adapted accordingly.

FIG. 4 further shows that at least the upper end of the post 25 has been provided with a flattened part 30 that has been integrally formed with the post 25, for instance by means of a punch treatment. This flattened part 30 serves as engagement for the exemplary embodiments of the locking means and the resistance means as described below.

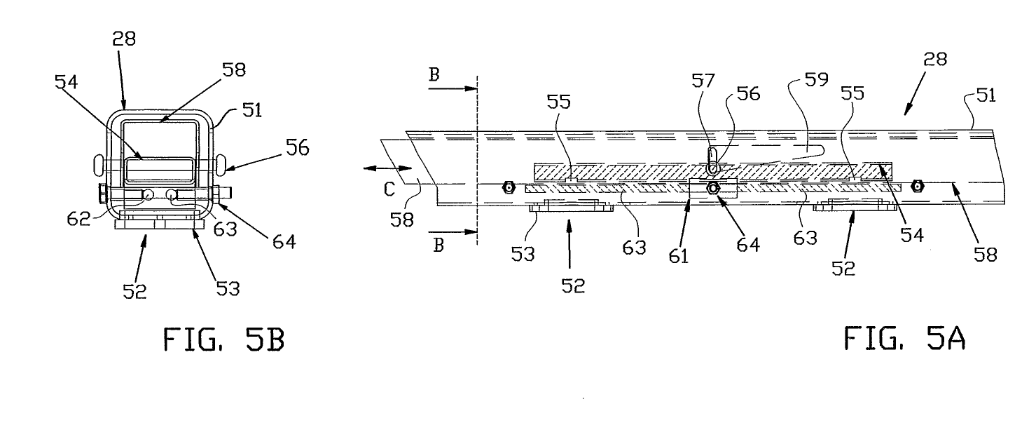

FIG. 5 shows an exemplary embodiment of the upper girder 28 including locking means according to the invention. In this exemplary embodiment the upper girder 28 is designed like a tube 51 which at its lower side 52 is provided with openings for passing the ends 30 of the posts 25, 26 (not shown) through. In said openings synthetic bearings 53 (for instance nylon slide bearings) have been placed that are able to accommodate the posts 25, 26 so as to be rotatable.

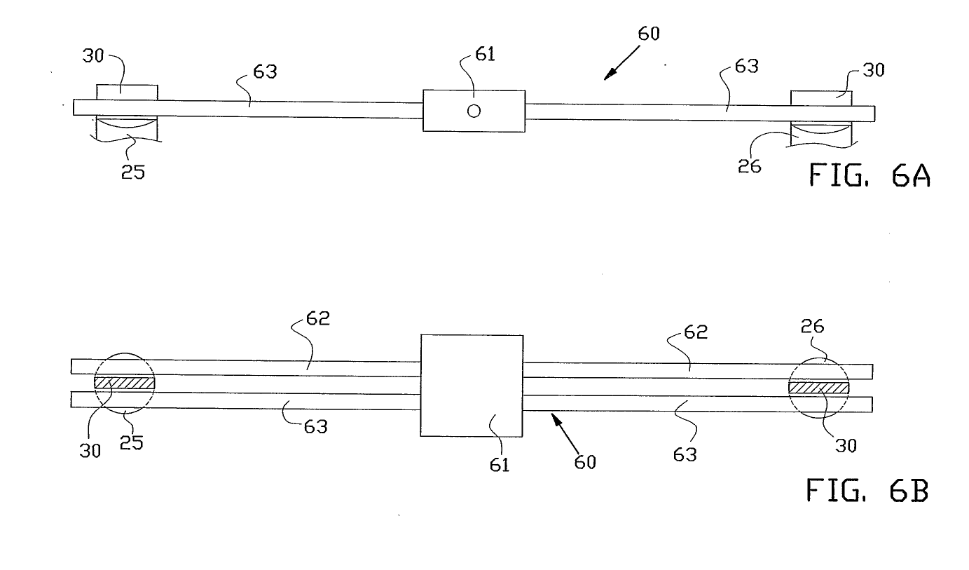

Above the synthetic bearings 53 resistance means 60 have been arranged in the tube 51, as shown in detail in FIG. 6. Said resistance means 60 comprise a block 61, preferably made of a synthetic material, in which two steel springs with circular cross-section 62, 63 have been placed so that they project on both sides of the block 61 over a distance to above the bearings 53 of the posts 25, 26. If placed in the bearings 53, the flattened parts 30 of the posts 25, 26 in the open position extend between the springs 62, 63 as shown in FIG. 6B. As a result the springs 62, 63 will counteract a rotation of the posts 25, 26 and exert a spring force on the posts 25, 26 in order to push them to the open position of FIG. 6B. The block 61 is fixedly connected to the tube 51 by means of a screwed connection 64.

Above said resistance means 60 a tubular locking girder 54 has been placed which above the openings 52 has been provided with recesses 55 for accommodating the flattened ends 30 of the posts 25, 26 therein. The recesses 55 have been aligned such that the girder 54 is able to fall over the flattened ends 30 of the posts if the posts are rotated into the closed position. The recesses 55 ensure a substantially rotation-fixed connection between the ends of the posts 25, 26 and the locking girder 54.

The locking girder 54 is movably attached to the tube 51 via a pawl 56 that is fixedly connected to the girder 54 and which extends through a substantially vertically oriented slot 57 in the tube 51. By pushing the pawl 56 upward (optionally manually or by means of a drive) the girder 54 can be moved away from the ends 30 of the posts 25, 26 for unlocking the posts. After unlocking and after the animal A has left the feeding location, the posts 25, 26 can be rotated back substantially a quarter of a turn to the open position as shown in FIG. 2. By operating the pawl 56 the locking of an individual feeding location can be operated.

The exemplary embodiment as shown in FIG. 5 has also been provided with a mechanism for central locking and/or unlocking of the feeding locations along the feed barrier. For that purpose a rail, particularly a U-shaped rail 58 has been placed in the tube 51 so as to be movable along the tube 51. At the location of the pawl 56 the rail 58 has been provided with a slotted hole 59. At its bottom side the slotted hole 59 has been provided with an inclined part pushing the pawl 56 upward when the rail is pulled in the direction C. By providing the feed barrier with a handle or a drive (not shown) at its end for reciprocally moving the rail 59 in the direction C, all locking means coupled with the rail 59 can be jointly locked or unlocked, without walking along the front of the barrier being necessary.

It will be clear that the pawl 57 can also be operatively connected to a suitable drive for moving the locking girder 54 in vertical direction (along the slotted hole 57). The device may for instance be provided with an electric, pneumatic or hydraulic or other type of drive with which the feed barrier can be automatically operated.

It will furthermore be clear that the locking girder 54 may also be equipped with two spaced apart pawls (not shown) placed near the rotatable posts 25, 26. In that case the tube 51 has been provided with two substantially vertically oriented slots, each near the upper side of the posts 25, 26. In that case the posts 25, 26 can be individually unlocked by operating the individual pawls.

It will furthermore be clear that the locking means may also comprise a separate locking girder for each rotatable post 25, 26, wherein by means of a related pawl each locking girder has been placed in a slot in the tube 51 situated near the upper side of the related post.

Whereas the invention has been shown and described referring to certain exemplary embodiments thereof, it will be clear to the expert that various adaptations in shape and details can be made without deviating from the spirit and scope of protection of the invention as defined by the attached claims.

1-37. (canceled)

38. Feed barrier comprising a left and a right post bounding a feeding location for an animal,
wherein the left and the right post are rotatable about a first and second centre line, respectively, between an open and a closed position, and
wherein the left and the right post have a curved shape, wherein a part of the left and right post in the open position are bent away from each other in order to form a passage for the animal's head, and in the closed position are bent towards each other according to a shape substantially adapted to the shoulder blades and/or neck of the animal.

39. Feed barrier comprising a left and a right post bounding a feeding location for an animal,
wherein the left and the right post are rotatable about a first and second centre line, respectively, between an open and a closed position, and
wherein the left and the right post have a curved shape, wherein a part of the left and right post in the open position are bent away from each other in order to form a passage for the animal's head, and in the closed position are bent towards each other, wherein a section of the part facing the lower side of the feed barrier is bent concavely.

40. Feed barrier according to claim 39, wherein the distance between the left and right post in the section becomes substantially continuously smaller as a function of the distance to the lower side of the feed barrier.

41. Feed barrier according to claim 39, wherein in the closed position the course of the section of the left and right post also comprises a component that is oriented substantially transverse to feed barrier, wherein the section runs substantially continuously as a function of the distance to the lower side of the feed barrier.

42. Feed barrier according to claim 39, wherein the left and/or right post is curved in three or more planes.

43. Feed barrier according to claim 39, wherein the feed barrier comprises an upper girder and a lower girder, and wherein the left and the right post with their upper and lower ends are rotatably connected to the upper and lower girder, wherein the left and right post at a side of the part or below the part facing the lower girder in the open position are bent towards each other for forming a stop part for the animal's chest, wherein the stop part of the left and right post in closed position preferably extends substantially beyond a plane defined by the upper and lower girder.

44. Feed barrier according to claim 43, wherein the part of the left and right post in the closed position extends substantially beyond a plane defined by the upper and lower girder.

45. Feed barrier according to claim 39, wherein the first centre line is spaced apart from the second centre line, wherein the first centre line preferably is placed substantially parallel to the second centre line, and wherein the left and right post comprise a substantially mirror-symmetrical curved shape with respect to each other.

46. Feed barrier according to claim 39, further comprising locking means for detachably locking the posts in the closed position.

47. Feed barrier according to claim 46, wherein the left and right post each at an end thereof facing the locking means comprises an unround part, preferably integrally formed with the post, wherein the locking means comprise a locking girder, wherein the locking girder at a side facing the left and right post comprises closing means for in the closed position of the left and right post rotation-fixedly connecting the unround ends of the posts to the locking girder.

48. Feed barrier according to claim 47, wherein the closing means comprise recesses for at least partially accommodating the unround end of the left and/or right post.

49. Feed barrier according to claim 47, wherein the locking girder is movable in a direction towards the left and/or right post for rotation-fixedly connecting the unround ends of the posts to the locking girder, and in a direction away from the left and/or right post for uncoupling the unround ends of the posts and the locking girder.

50. Feed barrier according to claim 49, wherein the feed barrier comprises manual operating means and/or a drive comprising an electric, pneumatic or hydraulic drive, for moving the locking girder, at least for uncoupling the unround ends of the posts and the locking girder.

51. Feed barrier according to claim 50, wherein the manual operating means and/or the drive of various feeding locations can be operated individually.

52. Feed barrier according to claim 50, wherein the manual operating means and/or the drive of various feeding locations can be operated jointly.

53. Feed barrier according to claim 47, wherein the locking girder is connected to the feed barrier so as to be movable substantially between the first and second centre line.

54. Feed barrier according to claim 53, wherein the locking girder is placed in a guide that is preferably situated substantially in between the first and second centre line, wherein the guide guides the movement of the locking girder along a third centre line that is substantially parallel to the first and second centre line.

55. Feed barrier according to claim 54, further comprising a rail extending along the feed barrier, which rail is operatively connected to the locking girder for from one end of the feed barrier moving the locking girder along the guide away from the posts for uncoupling the posts and the locking girder.

56. Feed barrier according to claim 47, wherein the locking girder extends to above the left and right post.

57. Feed barrier according to one claim 39, wherein the left and right post each at an end thereof comprise an unround part, and wherein the feed barrier comprises resistance means cooperating with the unround ends of the left and right post for offering resistance to the posts rotating out of the open position.
